(19) United States
(12) Patent Application Publication
(10) Pub. No.: US 2002/0117890 A1
(43) Pub. Date: Aug. 29, 2002

(54) Method of manufacturing a transverse support as a component of a twist beam axle

(76) Inventors: Klaus Glaser, Salzkotten (DE); Wigbert Christophliemke, Schloss Holte-Stuckenbrock (DE)

Correspondence Address: Friedrich Kueffner, Suite 910, 317 Madison Avenue, New York, NY, 10017, US

(21) Appl. No.: 10/135,284

(22) Filed: Apr. 30, 2002

Related U.S. Application Data
(62) Division of application No. 09/651,432, filed on Aug. 30, 2000.

(30) Foreign Application Priority Data
Sep. 2, 1999 (DE) 299 15 351.7
Sep. 2, 1999 (DE) 299 15 438.6
Aug. 18, 2000 (DE) 200 14 433.2

(51) Int. Cl. B60B 35/00

(52) U.S. Cl. 301/127

(57) ABSTRACT

A transverse support as a component of a twist beam axle of a passenger car has a bending resistant, torsionally yielding tubular profiled member formed by cold-forming a tube blank of a micro-alloyed, high-strength steel or a polyphase, higher strength steel, wherein the profiled member has a torsionally yielding central longitudinal section with a double-wall cross-section and opposed torsion-proof end sections. The tubular profiled member can also be made of special steel such as a stainless high-alloy chrome steel.

### BACKGROUND OF THE INVENTION

1. Field of the Invention

The invention relates to a transverse support for a twist beam axle of a passenger car.

2. Description of the Related Art

Various suggestions are known in regard to designs of transverse supports of a twist beam axle of a passenger car in order to provide them, on the one hand, with bending resistance and, on the other hand, with a sufficient torsional yield. Prior art references concerned with these problems are, for example, EP 0 249 537 B1, EP 0 681 932 A2, EP 0 752 332 B1, DE-Gm 297 20 207, and U.S. Pat. No. 2,069,911.

All of these transverse supports have in common that their manufacture overall is complex, and, accordingly, the producing costs within the context of a complete twist beam axle are high. In these known configurations it is particularly disadvantageous that because of the steels used for the tube blanks several heat treatments steps must be performed. For example, it is required to first anneal the cold-formed tubular profiled members, to subsequently hardened them, and then temper them in order to then subject them to further configuration processing steps for completing the twist beam axle. All of these method steps require special devices and various energy sources so that a suitable tubular profiled member can be provided.

### SUMMARY OF THE INVENTION

It is an object of the present invention to provide a transverse support as a component of a twist beam axle for passenger cars which, in comparison to the prior art, can be produced with a significantly simplified method.

In accordance with the present invention, this is achieved in that, according to a first variant, the bending-resistant, torsional yielding tubular profiled member of the transverse support is formed by cold-forming of a tube blank of micro-alloyed, high-strength steel and comprises a torsionally yielding, central longitudinal section with double-wall U-shaped cross-section as well as torsion-proof end sections.

An important aspect of the invention is the fact that the tube blank provided for cold-forming, independent of its cross-section, is now formed of a micro-alloyed steel of higher strength. Such a steel fulfills the conditions which are required of a transverse support as a component of a twist beam axle of a passenger car. The elimination of the heat treatment steps, including the associated energy sources and devices as well as the time expenditure, provides in the context of the invention a highly economic production especially because of the substantially shorter manufacturing time. An economic production results inevitably also in a more cost-effective manufacture with the result that the twist beam axle can also be produced more cost-effectively which, in the end, also affects the costs of a passenger car.

Accordingly, the tube blank for the transverse support can be comprised of cold-rolled or hot-rolled micro-alloyed steel of higher strength.

Preferably, the tube blank is comprised of a steel of the specification S420NC.

In accordance with the present invention, the object is moreover achieved in that, according to a second variant, the bending-resistant, torsionally yielding tubular profiled member of the transverse support is produced by cold-forming a tube blank comprised of a polyphase steel of higher strength and is comprised of a torsionally yielding central longitudinal section with double-wall U-shaped cross-section as well as torsion-proof end sections.

Accordingly, the tube blank provided for cold-forming, independent of its cross-section, is formed of a polyphase steel of higher strength. Such a steel fulfills also the conditions which are required of a transverse support of a component of a twist beam axle of a passenger car. Otherwise, the same advantages as mentioned in regard to the features of the first variant apply also in this context.

The tube blank for the transverse support can be comprised of a cold-rolled or hot-rolled polyphase steel of higher strength. Preferably, a dual-phase (DP) steel is used. In particular, the tube blank is comprised of a steel of the specification DP 600.

The tube blank may also be comprised of ferritic-bainitic steel.

In accordance with the present invention, the object is moreover achieved in that, according to a third variant, the bending-resistant, torsionally yielding tubular profiled member of the transverse support is comprised of special steel, especially of a stainless high-alloy chrome steel, and is comprised of a torsional yielding central longitudinal section with double-wall U-shaped cross-section as well as torsion-proof end sections.

By using special steel, a further cost and weight reduction of the transverse support can be achieved. The special steel used in this context has a high extension and is therefore easily formable. By work-hardening a high mechanical strength is achieved. Overall, these advantages result in a high service life of the twist beam axle in general and of the transverse support in particular.

It is furthermore advantageous that the application of paint or coatings on the transverse support is no longer required.

The configuration of the transverse support can be different depending on the function of the respective requirements. For example, the end sections may have a circular cross-section.

However, it is also possible that the end sections have a cross-section which deviates from the circular shape. Such a cross-section can be oval or shoe-shaped. This means that even for a shoe-shaped end section the cross-section is still U-shaped and of a double-wall construction. Such an end section is only of a larger size for connection to the longitudinal control arm.

Furthermore, it is possible that, independent of the configuration of the end sections, the tubular profiled member, especially at the transition from the U-shaped central longitudinal section into the torsion-proof end sections, is provided with stiffening grooves which can be formed inwardly or outwardly.

Moreover, it is possible to subject at least the outer surface of the tubular profiled member to a special mechanical surface hardening process. Optionally, the inner surface can also be surface hardened.

Such a surface configuration is carried out preferably by bombarding at least the outer surface of the tubular profiled member with balls, especially steel balls.

### BRIEF DESCRIPTION OF THE DRAWING

In the drawing:

FIG. 1 is a perspective view of a twist beam axle of a passenger car;

FIG. 2 is a plan view onto a tubular profiled member as a transverse support for the twist beam axle according to FIG. 1;

FIG. 3 is a cross-sectional view of the tubular profiled member of FIG. 2 along the line III-III;

FIG. 4 is a cross-sectional view of the tubular profiled member of FIG. 2 along the line IV-IV;

FIG. 5 is a cross-sectional view of the tubular profiled member of FIG. 2 along the line V-V;

FIG. 6 is a cross-sectional view of the tubular profiled member of FIG. 2 along the line VI-VI.

### DESCRIPTION OF THE PREFERRED EMBODIMENTS

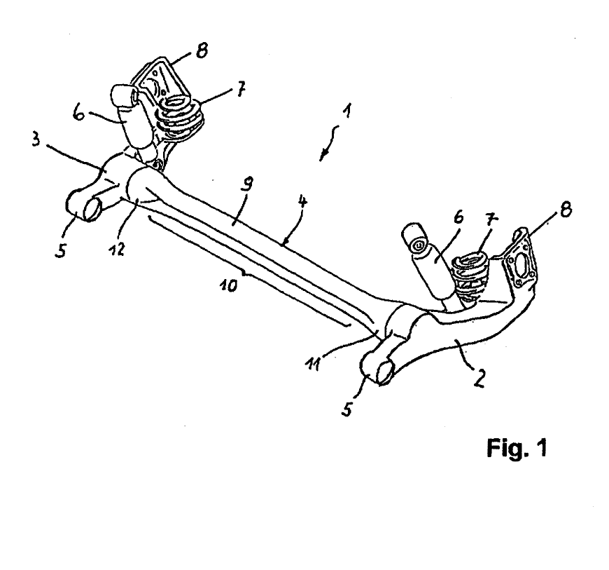

The twist beam axle 1 illustrated in FIG. 1 in the form of a twist beam rear axle comprises substantially two wheel guiding longitudinal control arms 2, 3 and a transverse support 4 connecting the two longitudinal control arms 2, 3. A bearing bushing 5 for an elastic pivotal connection to a vehicle chassis, not shown, is provided at the front ends of the longitudinal control arms 2, 3, respectively. Between the longitudinal control arms 2, 3 and the vehicle chassis shock absorbers 6 and springs 7 are arranged. Mounts 8 are provided at the rearward end of the longitudinal control arms 2, 3 to receive a wheel carrier for supporting the wheel.

The transverse support 4 is comprised of a tubular profiled member 9. The tubular profiled member 9 is produced of an initially round tube blank R (FIG. 6) which is comprised of a micro-alloyed steel of higher strength, for example, a steel of the specification S420NC. The tube blank R, however, may also be comprised of a polyphase steel of higher strength. Moreover, the use of a special steel, especially a stainless high-alloy chrome steel, is conceivable.

During the non-cutting cold-forming step, the cross-section 11 of the tube blank R is maintained at the end sections a of the tubular profiled member 9. However, this circular cross-section 11 of the end sections a has a continuous transition in the area of the transition sections b into a U-shaped double-wall cross-section 10 which is present within the central longitudinal section c of the tubular profiled member 9 (FIGS. 1 through 6).

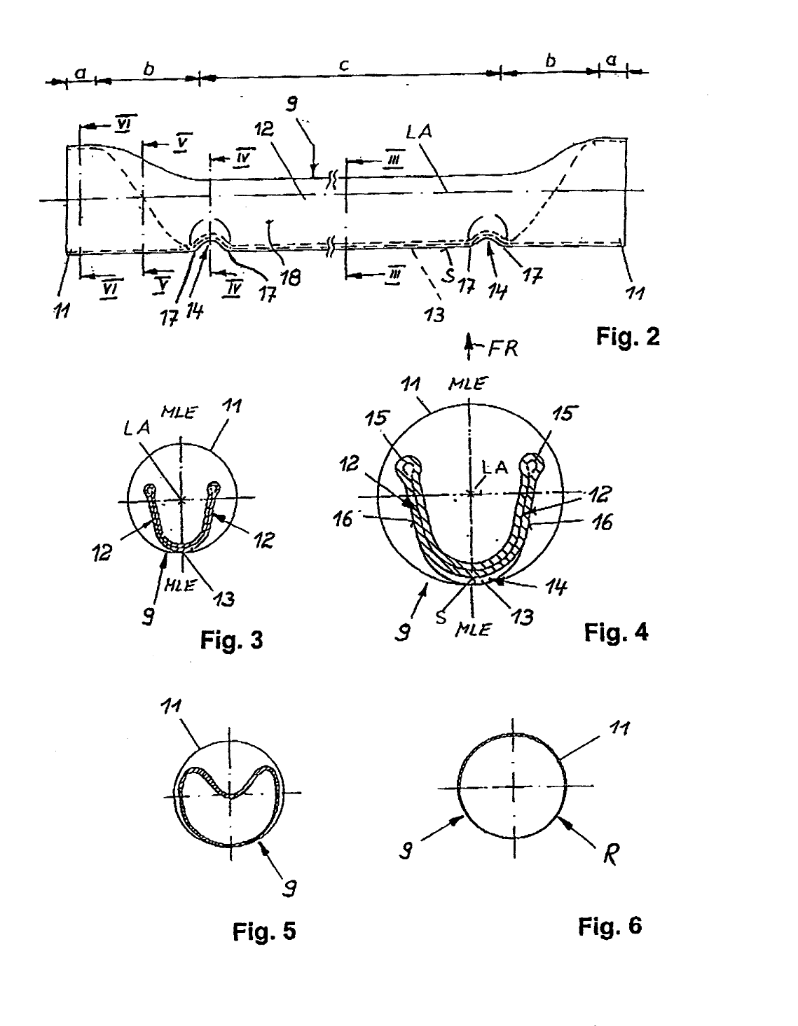

Assuming that the tubular profiled member 9 according to FIG. 2 is illustrated in a plan view, i.e., in a mounted position within the passenger car, the legs 12 of the central U-shaped longitudinal section c (FIGS. 3 and 4) extend from an arc-shaped stay 13 with slight divergence relative to the horizontal central longitudinal plane MLE extending through the longitudinal axis LA in the direction of travel FR (FIG. 4).

The tubular profiled member 9 is provided with groove-like embossments 14 at the ends of the central U-shaped longitudinal section c. These embossments 14 extend in a direction transverse to the tubular profiled member 9. FIG. 4 shows that the embossments 14 have the greatest depth at the apex S of the U-shaped longitudinal section c located in the horizontal central longitudinal plane MLE. The depth of the embossments decreases in the direction toward the free ends 15 of the legs 12 until they uniformly adjoin the outer surface 16 of the legs 12. Viewed in longitudinal section, the embossments 14 thus have a sickle-shaped configuration.

The edges 17 of the embossments 14 are rounded (FIG. 2).

For example, after cold-forming of a circular tube blank R comprised of a micro-alloyed steel of higher strength of the specification S420NC, the tubular profiled member 9 must not undergo any further heat treatment. It is only bombarded with steel balls on its outer surface 18 and subsequently subjected to further configuration processing steps for completing the twist beam axle 1.

While specific embodiments of the invention have been shown and described in detail to illustrate the inventive principles, it will be understood that the invention may be embodied otherwise without departing from such principles.

What is claimed is:

1. A transverse support as a component of a twist beam axle of a passenger car, the transverse support comprised of a bending resistant, torsionally yielding tubular profiled member formed by cold-forming a tube blank comprised of a micro-alloyed high-strength steel, wherein the profiled member is comprised of a torsionally yielding central longitudinal section with a double-wall cross-section and opposed torsion-proof end sections.

2. The transverse support according to claim 1, wherein the tube blank is comprised of a cold-rolled or hot-rolled micro-alloyed steel of higher strength.

3. The transverse support according to claim 1, wherein the tube blank is comprised of a steel of the specification S420NC.

4. The transverse support according to claim 1, wherein the end sections have a circular cross-section.

5. The transverse support according to claim 1, wherein the end sections have a cross-section deviating from a circular shape.

6. The transverse support according to claim 1, wherein at least an outer surface of the tubular profiled member is hardened.

7. The transverse support according to claim 1, wherein at least the outer surface of the tubular profiled member is hardened by bombardment with steel balls.

8. A transverse support as a component of a twist beam axle of a passenger car, the transverse support comprised of a bending resistant, torsionally yielding tubular profiled member formed by cold-forming a tube blank comprised of a polyphase steel of higher strength, wherein the profiled member is comprised of a torsionally yielding central longitudinal section with a double wall cross-section and opposed torsion-proof end sections.

9. The transverse support according to claim 8, wherein the tube blank is comprised of a cold-rolled or hot-rolled polyphase steel of higher strength.

10. The transverse support according to claim 9, wherein the tube blank is comprised of a dual-phase steel.

11. The transverse support according to claim 8, wherein the tube blank is comprised of a steel of the specification DP 600.

12. The transverse support according to claim 8, wherein the tube blank is comprised of a ferritic-bainitic steel.

13. The transverse support according to claim 8, wherein the end sections have a circular cross-section.

14. The transverse support according to claim 8, wherein the end sections have a cross-section deviating from a circular shape.

15. The transverse support according to claim 8, wherein at least an outer surface of the tubular profiled member is hardened.

16. The transverse support according to claim 8, wherein at least the outer surface of the tubular profiled member is hardened by bombardment with steel balls.

17. A transverse support as a component of a twist beam axle of a passenger car, the transverse support comprised of a bending resistant, torsionally yielding tubular profiled member comprised of special steel, wherein the profiled member is comprised of a torsionally yielding central longitudinal section with a double wall cross-section and opposed torsion-proof end sections.

18. The transverse support according to claim 17, wherein the special steel is a stainless high-alloy chrome steel.

19. The transverse support according to claim 17, wherein the end sections have a circular cross-section.

20. The transverse support according to claim 17, wherein the end sections have a cross-section deviating from a circular shape.

21. The transverse support according to claim 17, wherein at least an outer surface of the tubular profiled member is hardened.

22. The transverse support according to claim 17, wherein at least the outer surface of the tubular profiled member is hardened by bombardment with steel balls.

23. A method of manufacturing a transverse support as a component of a twist beam axle of a passenger car, the method comprising
initially manufacturing a tube blank from a cold-rolled or hot-rolled dual-phase steel of higher strength,
subsequently cold-forming from the tube blank a tubular profiled member comprised of a torsionally yielding central longitudinal section having a U-shaped double-wall cross-section and torsion-proof end sections, and
hardening at least an outer surface of the tubular profiled member.

24. The method according to claim 23, comprising using a cold-rolled or hot-rolled dual-phase steel of the specification DP600.

25. The method according to claim 23, comprising shaping the end sections of the tubular profiled member during cold-forming with a circular cross-section.

26. The method according to claim 23, comprising shaping the end sections of the tubular profiled section during cold-forming with a cross-section deviating from a circular shape.

27. The method according to claim 23, comprising hardening at least the outer surface of the tubular profiled member by bombardment with balls.

28. The method according to claim 27, comprising hardening at least the outer surface of the tubular profiled member by bombardment with steel balls.
